(19) United States
(12) Patent Application Publication
(10) Pub. No.: US 2018/0263243 A1
(43) Pub. Date: Sep. 20, 2018

(54) NOVEL PLANT PROTECTING COMPOSITIONS AND USES THEREOF

(71) Applicant: Flechsig Patent Company LLC, Cham (CH)

(72) Inventors: Frank FLECHSIG, Wohlen (CH); Thomas FLECHSIG, Hermetschwil-Staffeln (CH)

(73) Assignee: Flechsig Patent Company LLC, Cham (CH)

(21) Appl. No.: 15/762,695

(22) PCT Filed: Sep. 21, 2016
(86) PCT No.: PCT/EP2016/001578

§ 371 Date: Mar. 23, 2018

(30) Foreign Application Priority Data
Sep. 25, 2015 (CH) 1395/15

(51) Int. Cl. A01N 47/44; A01N 25/02

(52) U.S. Cl. CPC A01N 47/44; A01N 25/02

(57) ABSTRACT

The invention relates to a plant protecting composition or agricultural pesticide, comprising a substance which is selected from the group comprising poly(alkyl)guanidines, poly(alkyl)biguanidines, polyguanines or octenidin, or any blends of substances of this group. In a preferred embodiment, the substance which is selected from the group comprising poly(alkyl)guanidines, poly(alkyl)—biguanidines, polyguanines or octenidin, or any blends of substances of this group, is present in combination with at least one other component exhibiting activity against agricultural pests. Said least one other component exhibiting activity against agricultural pests may represent at least one active agent of a commercially known pesticide. A further aspect of the invention relates to a method for protecting plants against plant pathogens comprising the application of the above agricultural pesticide compositions.

### TECHNICAL FIELD

The present invention relates to a plant protecting agent or composition, based on a chemical active agent or a composition of chemical active agents.

Plant protecting agents are commonly defined as pesticides and herbicides which are in particular applied for the protection of plants, more specifically chemical or biological agents and compositions which are designed:
1) to protect plants and plant products against pathogenic organisms or to prevent their action;
2) to influence the life/vitality of plants in some other manner (e.g. growth regulators);
3) to preserve plant products (e.g. seed protecting agents);
4) to destroy undesired plants or parts of plants or to inhibit or prevent any undesirable growth of plants (herbicides).

The present invention relates in particular to a plant protecting agent according to group 1 above, which is based on a chemical agent or a composition of chemical agents. The corresponding pathogenic organisms are usually denominated as plant pathogens.

### PRIOR ART

A variety of plant protecting agents of group 1 are known in the prior art.

Some of these known and commercially available agricultural pesticides can only be applied in relatively low dosages and under strictly controlled conditions due to their toxicity for, e.g. fish stock, animals, other organisms, plants in the soil etc.

Also an issue for a number of commercially available agricultural pesticides is the development of resistances by many pathogenic microorganisms. Thus, there remains a strong need for further chemical agents or chemical compositions having activity against plant pathogens and this is reflected by ongoing research and development efforts.

The main objects of the present invention are to provide a plant protecting agent or agricultural pesticide which is effective against plant pathogens and concurrently is not or hardly toxic for other plants or organisms in the required ranges of concentration for the contemplated application as a plant protecting agent.

These objectives are achieved by an agricultural pesticide having the features of claim 1 or claim 4. Further aspects of the invention and more specific embodiments are the subject of further claims.

### DESCRIPTION OF THE INVENTION

The agricultural pesticide according to claim 1 comprises a substance from the group of poly(alkyl)guanidines (alternatively denoted or known as poly(alkylen)guanidines), poly(alkyl)biguanidines (or poly(alkylen)biguanidines), polyguanines or octenidin or any blends of substances of this group.

These substances are advantageous in that they are exhibiting antimicrobial activity but are not toxic for humans and animals, at least not in the required ranges of concentration for the contemplated application as a plant protecting agent.

In particular, the substances used according to the present invention show a broad-spectrum effect against bacteria, fungi and viruses in the field of plant pathogens.

The advantageous broad-spectrum effect of these substances, in particular poly(hexamethylen)guanidine (PHMG) and poly-(hexamethylen)biguanidine (PHMB), is especially surprising since the anti-bacterial effect of such poly(alkyl)guanidines or poly(alkyl)biguanidines was previously only known with respect to some specific bacteria, in particular human-pathogenic bacteria such as Staphylococcus aureus, Pseudomonas aeruginosa and Salmonella choleraesuis.

The anti-bacterial activity of the cationic polymer poly-(hexamethylen) guanidine-hydrochloride (PHMGH) against human pathogenic microorganisms with respect to iatrogenic infections was described in this context for example in the following publication (Journal of Medical Microbiology (2008), 57, 1523-1528: “Polyhexamethylene guanidine hydrochloride-based disinfectant; a novel tool to fight meticillin-resistant staphylococcus aureus and nosocomial infections”, Mathias K. Oule et al.). In particular, the publication “Mathias K. Oule et al.” addresses the antimicrobial effectivity of PHMGH as a novel tool for fighting a meticillin-resistant human-pathogenic Staphylococcus aureus.

The term “plant-pathogen” in the context of the present invention refers to microorganisms, in particular bacteria, fungi and viruses, which act as pathogenic organisms against plants or plant products.

Many plant pathogens, such as for example fungi, are spore forming organisms. Especially surprisingly, it has been found that the agricultural pesticide according to the invention shows a high antimicrobial activity against a broad variety of spore forming organisms.

The agricultural pesticide according to the invention has for example shown to be effective in particular against plant pathogens like the bacterium Erwinia amylovora (fire blight), the fungus Phytophthora infestans (late blight), Venturia inaequalis (apple scab) and ascomycetes of the genera Fusarium. However, the applicability of the claimed agricultural pesticide is by no means limited to these organisms and a variety of further target pathogens are disclosed below.

In a preferred aspect of the present invention, the agricultural pesticide represents a composition wherein the substance which is selected from the group comprising poly(alkyl)guanidines, poly(alkyl)biguanidines, polyguanidines or octenidin, or any blends or substances of these groups is present in combination with at least one other component exhibiting activity against agricultural pests.

More specifically, said other component exhibiting activity against agricultural pests represents a commercially known or available pesticide or at least one active agent of a commercially known or available pesticide.

It has been found that by the means of such a combination the dosage of a plurality of commercially available pesticides can be reduced up to 90% without loss of the antimicrobial effectivity.

Further, it has even been demonstrated that for a number of commercially available agricultural pesticides an increase of the antimicrobial activity can be achieved while still applying the same dosage of those pesticides (albeit in combination with the substances of claim 1). This is in particular advantageous, since usually an increase of the antimicrobial activity of such commercial pesticides is not possible by just increasing the dosage of the commercial pesticides due to strict regulatory limits.

Such commercially available agricultural pesticides, in particular those belonging to the above group 1) of plant protecting agents, may be classified according to their chemical nature and their corresponding mechanisms or modes of activity for example in the following categories (according to the Fungicide Resistance Activity Committee (FRAC)):
A) Azoles (trade names: Opus Top, Input, Agent, Caramba)
B) Benzimidazole Carbamates (trade names: Duett Ultra, Don-Q, Paroli, Topsin)
C) Carboxamides (trade names: Input Xpro, Varian Xpro, Aviafor Xpro, Champion, Adexar)
D) Amines (trade names: Input Xpro, Rubin TT, pronto Plus, Input Classic, Ceralo, Prolectus)
E) Strobulines (trade names: Amistar, Ortiva, Stroby, Discus, Acanto, Flint)
F) Application as a contact agent (trade names: Delan, Infinito, Acrobat Plus, Tatto, Tridex, Revus, MZ, Ridomil Gold)

Further commercial products beyond these categories according to FRAC are Vegas, Dynali, Capalo, Fleity, Vivando. The categorisation “contact agent” is based on the application form by means of contacting the surface of plants.

Typically, in the agricultural pesticide according to the present invention said least one other component exhibiting activity against agricultural pests is selected from the group of compounds comprising azoles, in particular diazoles, triazoles, benzimidazoles, and pyrazoles, carbamates, in particular benzimidazole carbamates and dithiocarbamates, carboxamides, dicarboximides, anilides, nicotinamides, amines and ammonium compounds, including spiroketalamines and heterocyclic compounds such as pyrimidines, pyridines, piperidines, morpholines, pyrroles, in particular phenylpyrroles, diazines, strobulines, nitriles, in particular chloronitriles, cinnamic acids.

In more specific embodiments, said least one other component exhibiting activity against agricultural pests is selected from the group comprising propyl-3-(dimethylamino) propylcarbamate hydrochloride (also known as Propamocarb-hydrochloride), 8-tert-butyl-1,4-dioxaspiro[4.5]decan-2-ylmethyl-(ethyl)(propyl)amine (Spiroxamine, (RS)-2-(4-chlorophenyl)-N-[3-methoxy-4-(prop-2-ynyloxy)phenethyl]-2-(prop-2-ynyloxy)acetamide (Mandipropamide), methyl N-methoxyacetyl)-N-2,6-xylyl-D-alaninate (Metalaxyl-M), N-propyl-N-[2-2,4,6-trichlorophenoxy)ethyl]imidazole-1-carboxamide (Prochloraz), N-4,6-dimethylpyrimidin-2-yl)aniline (Pyrimethanil), methyl (E)-3-methoxy-2-{2-6-(trifluoromethyl)pyridin-2-yloxymethyl]-phenyl}acrylate (Picoxystrobin), (E)-{2-[6-(2-chlorophenoxy)-5-fluoropyrimidin-4-yloxy]phenyl)(5,6-dihydro-1,4,2-dioxazin-3-yl)methanone (Fluoxastrobin), 3-(difluoromethyl)-1-methyl-N-(3′,4′,5′-trifluorobiphenyl-2-yl)pyrazole-4-carboxamide (Fluoxapyroxad), S-allyl 5-amino-2,3-dihydro-2-isopropyl-3-oxo-4-(o-tolyl)pyrazole-1-carbothioate (Fenpyrazamine), tetrachloroisophthalonitrile (Chlorothalonil), 3-(3,5-dichlorophenyl)-N-isopropyl-2,4-dioxoimidazolidine-1-carboxamide (Iprodion), N-(3′,4′-dichloro-5-fluorobiphenyl-2-(Bixafen), dimethyl 4,4′-(o-phenylene)bis(3-thioallophanate) (Thiophanate-methyl), 2-chloro-N-(4′-chlorobiphenyl-2-yl)nicotinamide (Boscalid), 5,10-dihydro-5,10-dioxonaphtho[2,3-b]-1,4-dithi-in-2,3-dicarbonitrile (Dithianon), methyl (E)-2-{2[6-(2-cyanophenoxy)pyrimidin-4-yloxy)phenyl}3-methoxyacrylate (Azoxystrobin), (E,E)-methoxyimino-{2-[1-(3-trifluoromethyl-phenyl)-ethylideneaminooxymethyl]-phenyl}-acetic acid methyl ester (Trifloxystrobin), 2,6-dichloro-N-[3-chloro-5-(trifluoromethyl)-2-pyridylmethyl)benzamide (Fluopicolide), (+/−)-cis-4-[3-(4-tert-butylphenyl)-2-methylpropyl]-2,6-dimethylmorpholine (Fenpropimorph), (E,Z 4-[3-(4-chlorophenyl)-3-(3,4-dimethoxyphenyl)-acryloyl]-morpholine (Dimethomorph), (RS)-1-[3-(4-tert-butylphenyl)-2-methylpropyl)piperidine (Fenpropidine), (RS)-1-p-chlorophenyl-4,4-dimethyl-3-(1H-1,2,4-triazol-1-ylmethyl)pentan-3-ol (Tebuconazole), (1RS,2RS,1RS,2SR)-1-(4-chlorophenoxy)-3,3-dimethyl-1-(1h-1,2,4-triazole-1-yl)butan-2-ol (Triadimenol), 1-(2,4-dichloro-beta-propylphenethyl)-1H-1,2,4-triazole (Penconazole), (1RS,5RS,1RS,5SR)-5-(4-chlorobenzyl)-2,2-dimethyl-1-(1H-1,2,4-triazol-ylmethyl)cyclopentanol (Metconazole), (RS)-2-[2-(1-chlorocyclopropyl)-3-[2-chlorophenyl)-2-hydroxypropyl]-2,4-dihydro-1,2,4-triazole-3-thione (Prothioconazole), (2RS,3RS)-1-[3-(2-chlorophenyl)-2-(4-fluoro-phenyl)oxiran-2-ylmethyl]-1H-1,2,4-triazole (Epoxiconazole), (+/−)-(E)-5+(4-chlorobenzylidene)-2-2-dimethyl-1-(1H-1,2,4-triazol-1-methyl)cyclopentanol (Triticonazole), (+/−)-1-[2-(2,4-dichlorophenyl)-4-propyl-1,3-dioxolan-2-ylmethyl]-1H-1,2,4-triazole (Propiconazole), manganese ethylenebis-(dithiocarbamate) polymeric complex with zinc salt (Mancozeb), methyl-(E)-2-methoxyimino-(2)-o-tolyloxy-methyl(phenyl)acetate (Kresoxim-methyl).

The agricultural pesticide according to the present invention comprising a substance which is selected from the group comprising poly(alkyl)guanidines, poly(alkyl)biguanidines, polyguanines or octenidin, or any blends of substances of this group, may be present in an aqueous formulation in a proportion between 10 ppm and 500.000 ppm, preferably between 10 ppm and 200.000 ppm, more preferably between 20 ppm and 40.000 ppm, of the total composition.

For example, when the poly(alkyl)guanidine, in particular PHMG, is applied in an aqueous formulation, typically it is comprised therein in a proportion between 10 ppm to 200.000 ppm, more preferably between 20 ppm to 40.000 ppm.

Preferred ranges for an exemplary composition based on PMHG as a representative of the poly(alkyl)guanidines are compiled in the following Table 1:

TABLE 1

| | Content (ppm of the total |
|---|---|
| Substance | composition) |
| Poly(hexamethylene)guanidine | 10 ppm to 200.000 ppm, more |
| (PHMG) | preferred 20 to 40.000 ppm |
| Water | 999.990 ppm to 800.000 ppm, |
| | more preferred 999.980 to |
| | 960.000 ppm |

Preferably, the agricultural pesticide according to the invention is adjusted to a pH value in the range of 3 to 8.

As already mentioned above, in a preferred aspect of the present invention the agricultural pesticide represents a composition wherein the substance which is selected from the group comprising poly(alkyl)guanidines, poly(alkyl)-biguanidines, polyguanidines or octenidin, or any blends or substances of these groups is present in combination with at least one other component exhibiting activity against agricultural pests.

In this case, the substance which is selected from the group comprising poly(alkyl)guanidines, poly(alkyl)biguanidines, polyguanines or octenidin, or any blends of substances of this group, is typically present in a proportion between 10 ppm and 200.000 ppm, preferably between 20 ppm und 8000 ppm, of the total composition.

For example, PHMG is typically comprised in combination with an active agent of a commercially available agricultural pesticide in a formulation preferably between 10 to 200.000 ppm, more preferably comprised between 20 and 8.000 ppm.

In such a composition, the least one other component exhibiting activity against agricultural pests is typically present in a proportion between 5 ppm and 20.000 ppm, preferably between 10 ppm und 5000 ppm, of the total composition.

In the agricultural pesticide according to the present invention, the poly(alkyl)guanidines, poly(alkyl)biguanidines or polyguanines may have a molecular weight in the range from 500 to 100.000 Dalton, such as 500 or 1000 to 40.0000 Dalton, preferably 500 or 1000 to 10.000 Dalton, 500 to 6.000 Dalton or 1000 to 4.000 Dalton.

In the agricultural pesticide according to the present invention, the poly(alkyl)guanidines or poly(alkyl)-biguanidines may have an alkyl(en) chain length of the monomer in the range from C₂ to C₂₀, preferably in the range from C₂ to C₁₄, and a degree of polymerisation n (number of monomeric alkylen units in the polymer) in the range from 5 to 600, preferably in the range from 5 to 300.

In particular, the poly(alkyl)guanidine may be selected from the group comprising a poly(tetramethylen)guanidine, poly(hexamethylen)guanidine (PHMG), a poly(octamethylen)-guanidine, poly(decamethylen)guanidine, poly(dodeca-methylen)guanidine or blends thereof.

Some specific embodiments of the agricultural pesticide according to the present invention are aqueous compositions comprising poly(hexamethylen)guanidine in an amount of 20-8000 ppm, and one or more of compounds selected from the group comprising 2,6-dichloro-N-[3-chloro-5-(trifluoro-methyl)-2-pyridylmethyl)benzamide, 5,10-dihydro-5,10-dioxonaphtho[2,3-b]-1,4-dithi-in-2,3-dicarbonitrile, methyl (E)-2-{2[6-(2-cyanophenoxy)pyrimidin-4-yloxy)phenyl}3-methoxyacrylate, propyl-3-(dimethylamino)propylcarbamate hydrochloride in an amount of 10-1000 ppm each and the balance of water.

Preferred ranges for an exemplary composition of active agents according to the invention based on a blend of PHMG with the commercially available pesticide active agent Dithianon (Delan®, Bayer) from the class of “contact agents” are:

TABLE 2

| | Content (ppm of the total |
|---|---|
| Substance | composition) |
| Poly(hexamethylene)guanidine | 10 ppm to 200.000 ppm, more |
| (PHMG) | preferred 20 to 8.000 ppm |
| Dithianon (Delan ®, Bayer) | 5 ppm to 2.000 ppm, more |
| | preferred 10 to 1.000 ppm |
| Water | 999.985 ppm to 798.000 ppm, |
| | more preferred 999.970 to |
| | 991.000 |

Preferred ranges for an exemplary composition of active agents according to the invention based on a blend of PHMG with the commercially available active agents Fluopicolid/Propamocarb-hydrochlorid (Infinito®, Bayer) from the class of “contact agents” are:

TABLE 3

| | Content (ppm of the total |
|---|---|
| Substance | composition) |
| Poly(hexamethylene)guanidine | 10 ppm to 200.000 ppm, more |
| (PHMG) | preferred 20 to 8.000 ppm |
| Propamocarb-hydrochlorid | 5 ppm to 1.500 ppm, more |
| (Infinito ®, Bayer) | preferred 10 to 800 ppm |
| Fluopicolid | 5 ppm to 1.000 ppm, more |
| (Infinito ®, Bayer) | preferred 10 to 250 ppm |
| Water | 999.975 ppm to 797.500 ppm, |
| | more preferred 999.960 to |
| | 990.950 |

Preferred ranges for an exemplary composition of active agents according to the invention based on a blend of PHMG with the commercially available pesticide agent Azoxystrobin (Amistar®, Syngenta) from the class of Strobilurines are:

TABLE 4

| | Content (ppm of the total |
|---|---|
| Substance | composition) |
| Poly(hexamethylene)guanidine | 10 ppm to 200.000 ppm, more |
| (PHMG) | preferred 20 to 8.000 ppm |
| Azoxystrobin | 5 ppm to 2.000 ppm, more |
| (Amistar ®, Syngenta) | preferred 10 to 500 ppm |
| Water | 999.985 ppm to 798.000 ppm, |
| | more preferred 999.970 to |
| | 991.500 |

Further suitable blends of PHMG with active agents of commercially available pesticides are compiled in Table 5 below.

The given proportions refer to a spray mixture which is typically applied in an amount of 1000 l/ha.

In Table 6 below a number of commercially available pesticides which are suitable for blending with poly(alkyl)guanidines, in particular PHMG, in the compositions according to the present invention, as well as suitable proportions in spray mixtures are compiled.

TABLE 5

| | | Proportion of | | | | | | | |
|---|---|---|---|---|---|---|---|---|---|
| | | Additional | | | | | | | |
| | | Agent in | | Proportion of | | PHMG in | | PHMG in | |
| | | blend | | Additional Agent | | blend | | blend | |
| | | applicable | | in blend | | applicable | | Preferred | |
| | | ppm | | preferred ppm | | ppm | | ppm | |
| | Additional Active Agent | min | max | min | max | min | max | min | max |
| 1 | Fenpropimorph | 5 | 4.000 | 10 | 1.000 | 5 | 20.000 | 10 | 5.000 |
| 2 | Epoxiconazole | 5 | 2.000 | 10 | 500 | 5 | 20.000 | 10 | 5.000 |
| 3 | Prothioconazole | 5 | 2.000 | 10 | 1.000 | 5 | 20.000 | 10 | 5.000 |
| 4 | Spiroxamine | 5 | 3.000 | 10 | 1.500 | 5 | 20.000 | 10 | 5.000 |
| 5 | Fenpropidin | 5 | 4.000 | 10 | 1.000 | 5 | 20.000 | 10 | 5.000 |
| 6 | Propiconazole | 3 | 3.500 | 10 | 750 | 3 | 20.000 | 10 | 5.000 |
| 7 | Metconazole | 5 | 1.500 | 10 | 500 | 5 | 20.000 | 10 | 5.000 |
| 8 | Thiophanat-methyl | 5 | 4.000 | 10 | 1.500 | 5 | 20.000 | 10 | 5.000 |
| 9 | Iprodion | 5 | 4.000 | 10 | 1.500 | 5 | 20.000 | 10 | 5.000 |
| 10 | Penconazole | 5 | 1.500 | 10 | 500 | 5 | 20.000 | 10 | 5.000 |
| 11 | Bixafen | 5 | 1.000 | 10 | 250 | 5 | 20.000 | 10 | 5.000 |
| 12 | Fluoxastrobin | 5 | 1.000 | 10 | 250 | 5 | 20.000 | 10 | 5.000 |
| 13 | Boscalid | 5 | 4.000 | 10 | 1.000 | 5 | 20.000 | 10 | 5.000 |
| 14 | Fluxapyroxad | 5 | 2.000 | 10 | 500 | 5 | 20.000 | 10 | 5.000 |
| 15 | Prochloraz | 2 | 250 | 5 | 75 | 2 | 20.000 | 10 | 5.000 |
| 16 | Pyrimethanil | 2 | 250 | 5 | 80 | 2 | 20.000 | 10 | 5.000 |
| 17 | Triticonazole | 2 | 250 | 5 | 50 | 2 | 20.000 | 10 | 5.000 |
| 18 | Tebuconazole | 5 | 3.000 | 10 | 1.500 | 5 | 20.000 | 10 | 5.000 |
| 19 | Triadimenol | 5 | 1.000 | 10 | 150 | 5 | 20.000 | 10 | 5.000 |
| 20 | Fenpyrazamine | 5 | 5.000 | 10 | 2.500 | 5 | 20.000 | 10 | 5.000 |
| 21 | Azoxystrobin | 5 | 8.000 | 10 | 1.000 | 5 | 20.000 | 10 | 5.000 |
| 22 | Kresoxim-methyl | 5 | 8.000 | 10 | 1.000 | 5 | 20.000 | 10 | 5.000 |
| 23 | Picoxystrobin | 5 | 8.000 | 10 | 1.000 | 5 | 20.000 | 10 | 5.000 |
| 24 | Trifloxystrobin | 5 | 8.000 | 10 | 1.000 | 5 | 20.000 | 10 | 5.000 |
| 25 | Dithianon | 5 | 2.000 | 10 | 1.000 | 5 | 20.000 | 10 | 5.000 |
| 26 | Propamocarb-hydrochlorid | 5 | 8.000 | 10 | 4.000 | 5 | 20.000 | 10 | 5.000 |
| 27 | Fluopicolid | 5 | 6.000 | 10 | 500 | 5 | 20.000 | 10 | 5.000 |
| 28 | Dimethomorph | 5 | 3.000 | 10 | 750 | 5 | 20.000 | 10 | 5.000 |
| 29 | Mancozeb | 5 | 10.000 | 50 | 5.000 | 5 | 20.000 | 10 | 5.000 |
| 30 | Mandipropamide | 5 | 2.500 | 10 | 1.000 | 5 | 20.000 | 10 | 5.000 |
| 31 | Metalaxyl-M | 5 | 2.500 | 10 | 1.000 | 5 | 20.000 | 10 | 5.000 |
| 32 | Chlorothalonil | 5 | 4.000 | 10 | 2.000 | 5 | 20.000 | 10 | 5.000 |

TABLE 6

| | | | | Applicable | | Preferred | | | | | |
|---|---|---|---|---|---|---|---|---|---|---|---|
| | | | | ppm in | | ppm in | | | | | |
| | | | | blends | | blends | | | | | |
| | | | | with PHMG | | with PHMG | | Regulatory | | spray | |
| | | | | (1000 l/ha) | | (1000 l/ha) | | Application | | 1000 l/ha | |
| | Suppplier | No. | Active agent | min | Max | min | max | Kg/ha | times/Year | ppm | Class |
| Opus Top | BASF | 1 | Fenpropimorph 250 g/l | 5 | 400 | 10 | 1000 | 0.375 | x | 375 | Morpholine |
| | BASF | 2 | Epoxiconazole 84 g/l | 5 | 200 | 10 | 500 | 0.126 | x | 126 | Triazole |
| Input | Bayer | 3 | Prothioconazole 160 g/l | 5 | 200 | 10 | 1000 | 0. | 2 | 240 | Triazole |
| | Bayer | 4 | Spiroxamine 300 g/l | 5 | 300 | 10 | 1500 | 0. | 2 | 450 | Spiroxamine |
| Agent | Syngenta | 5 | Fenpropidin 450 g/l | 5 | 400 | 10 | 1000 | 0. | x | 450 | Morpholine |
| | Syngenta | 6 | Propiconazole 125 g/l | 3 | 350 | 10 | 750 | 0. | x | 250 | Triazole |
| Caramba | BASF | 7 | Metconazole 60 g/l | 5 | 150 | 10 | 500 | 0. | 2 | 120 | Triazole |
| Topas | Syngenta | | Penconazole 100 g/l | 5 | 1500 | 10 | 500 | 0.05 | x | | Triazole |
| Duett Ultra | BaSF | 2 | Epoxiconazole 187 g/l | 5 | 2000 | 10 | 500 | 0.1402 | 2 | 141 | Triazole |
| | BaSF | 8 | Thiophanate-methyl 310 g/l | 5 | 4000 | 10 | 1500 | 0.225 | 2 | 225 | Benzimidazole |
| Don-Q | Spiess- | 8 | Thiophanate-methyl 704 g/l | 5 | 4000 | 10 | 1500 | 774.4 | 2 | 775 | Benzimidazole |
| Paroli | BaSF | 8 | Thiophanate-methyl 167 g/l | 5 | 4000 | 10 | 1500 | 0.501 | x | 501 | Benzimidazole |
| | BaSF | 9 | Iprodion 167 g/l | 5 | 4000 | 10 | 1500 | 0.501 | x | 501 | Imidazole |
| Input Xpro | Bayer | 3 | Prothioconazol 100 g/l | 5 | 2000 | 10 | 1000 | 0 | 2 | 150 | Triazole |
| | Bayer | 4 | Spiroxamine 250 g/l | 5 | 3000 | 10 | 1500 | 0.375 | 2 | 375 | Spiroxamine |
| | Bayer | 1 | Bixafen 50 g/l | 5 | 1000 | 10 | 250 | 0.075 | 2 | 75 | Carboxamide |
| Variano | Bayer | 3 | Prothioconazol 100 g/l | 5 | 2000 | 10 | 1000 | 0 | 1 | 150 | Triazole |
| | Bayer | 1 | Fluoxastrobin 50 g/l | 5 | 1000 | 10 | 250 | 0.075 | 1 | 75 | Strobuline |
| | Bayer | 1 | Bixafen 40 g/l | 5 | 1000 | 10 | 250 | 0 | 1 | 50 | Carboxamide |
| Aviafor | Bayer | 1 | Bixafen 75 g/l | 5 | 1000 | 10 | 250 | 0.112 | 2 | 113 | Carboxamide |
| | Bayer | 3 | Prothioconazol 150 g/l | 5 | 2000 | 10 | 1000 | 0.225 | 2 | 225 | Triazole |
| Champion | BASF | 2 | Epoxiconazol 67 g/l | 5 | 2000 | 10 | 500 | 0.100 | 2 | 100 | Triazole |
| | BASF | 1 | Boscalid 233 g/l | 5 | 4000 | 10 | 1000 | 0.349 | 2 | 350 | Carboxamide |
| Adexar | BASF | 2 | Epoxiconazol 62.5 g/l | 5 | 2000 | 10 | 500 | 0.125 | 2 | 125 | Triazole |
| | BASF | 1 | Fluxapyroxad 62.5 g/l | 5 | 2000 | 10 | 500 | 0.125 | 2 | 125 | Pyrazole |
| Input Xpro | Bayer | 3 | Prothioconazole 100 g/l | 5 | 2000 | 10 | 1000 | 0 | 2 | 150 | Triazole |
| | Bayer | 4 | Spiroxamine 250 g/l | 5 | 3000 | 10 | 1500 | 0.375 | 2 | 375 | Spiroxamine |
| | Bayer | 11 | Bixafen 50 g/l | 5 | 1000 | 10 | 250 | 0.075 | 2 | 75 | Carboxamide |
| Rubin TT | BaSF | 15 | Prochloraz 38.6 g/l | 2 | 250 | 5 | 75 | 0.0173 | 1 | 18 | Imidazole |
| | BaSF | 16 | Pyrimethanil 42 g/l | 2 | 250 | 5 | 80 | 0.018 | 1 | 19 | Anilino- |
| | BaSF | 17 | Triticonazole 25 g/l | 2 | 250 | 5 | 50 | 0.0112 | 1 | 12 | Azole |
| pronto | Bayer | 4 | Spiroxamine 250 g/l | 5 | 3000 | 10 | 1500 | 0.375 | 2 | 375 | Spiroxamine |
| | Bayer | 18 | Tebuconazole 133 g/l | 5 | 3000 | 10 | 1500 | 0.199 | 2 | 200 | Triazole |
| Input | Bayer | 3 | Prothioconazole 160 g/l | 5 | 2000 | 10 | 1000 | 0 | 2 | 240 | Triazole |
| | Bayer | 4 | Spiroxamine 300 g/l | 5 | 3000 | 10 | 1500 | 0 | 2 | 450 | Spiroxamine |
| Ceralo | Cheminova | 4 | Spiroxamine 250 g/l | 5 | 3000 | 10 | 1500 | 0 | 2 | 300 | Spiroxamine |
| | Cheminova | 18 | Tebuconazole 167 g/l | 5 | 3000 | 10 | 1500 | 0.200 | 2 | 201 | Triazole |
| | Cheminova | 19 | Triadimenol 43 g/l | 5 | 1000 | 10 | 150 | 0.051 | 2 | 52 | Triazole |
| Prolectus | Sumitomo | 20 | Fenpyrazamine 500 g/kg | 5 | 5000 | 10 | 2500 | 750 | 1 | 750 | Pyrazole |
| Amistar | Syngenta | 21 | Azoxystrobin | 5 | 8000 | 10 | 1000 | 0.5 | x | 500 | Strobuline |
| Ortiva | Syngenta | 21 | Azoxystrobin 250 g/l | 5 | 8000 | 10 | 1000 | 0.75 | x | 750 | Strobuline |
| Stroby | Leu & | 22 | Kresoxim-methyl 50% | 5 | 8000 | 10 | 1000 | 0.5 | 3 | 300 | Strobuline |
| | Gygax AG | | | | | | | | | | |
| Discus | BASF | 22 | Kresoxim-methyl 50% | 5 | 8000 | 10 | 1000 | 0.5 | x | 500 | Strobuline |
| Acanto | Dupont | 23 | Picoxystrobin 250 g/l | 5 | 8000 | 10 | 1000 | 0.25 | 2 | 250 | Strobuline |
| Flint | Bayer | 24 | Trifloxystrobin 500 g/kg | 5 | 8000 | 10 | 1000 | 0.625 | 2 | 625 | Strobuline |
| Delan | BASF | 25 | Dithianon | 5 | 2000 | 10 | 1000 | 0.3 | 8 | 750 | Contact Agent |
| Infinito | Bayer | 26 | Propamocarb-hydrochlorid | 5 | 8000 | 10 | 4000 | 1 | 4 | 1000 | Contact Agent |
| | Bayer | 27 | Fluopicolid | 5 | 6000 | 10 | 500 | 0.1 | 4 | 100 | Contact Agent |
| Acrobat | BASF | 28 | Dimethomorph 90 g/kg | 5 | 3000 | 10 | 750 | 0.36 | x | 360 | Contact Agent |
| | BASF | 29 | Mancozeb 600 g/kg | 5 | 10000 | 50 | 5000 | 2.4 | x | 2400 | Contact Agent |
| Tattoo | Bayer | 29 | Mancozeb 302 g/kg | 5 | 10000 | 50 | 5000 | 0.453 | 3 | 454 | Contact Agent |
| | Bayer | 26 | Propamocarb-Hydrochlorid | 5 | 2500 | 10 | 1000 | 0.372 | 3 | 373 | Contact Agent |
| Tridex | UPL Europe | 29 | Mancozeb 750 g/kg | 5 | 10000 | 50 | 5000 | 1.5 | | 1500 | Contact Agent |
| Revus | Syngenta | 30 | Mandipropamide 250 g/l | 5 | 2500 | 10 | 1000 | 0.4 | | 400 | Contact Agent |
| MZ | Syngenta | 29 | Mancozeb 600 g/kg | 5 | 10000 | 50 | 5000 | 1.5 | | 1500 | Contact Agent |
| | | 30 | Mandipropamide 50 g/l | 5 | 2500 | 10 | 1000 | 0.125 | | 125 | Contact Agent |
| Ridomil | Leu & G | 29 | Mancozeb 640 g/kg | 5 | 10000 | 50 | 5000 | 2.1 | | 2100 | Contact Agent |
| | | 31 | Metalaxyl-M 40 g/kg | 5 | 2500 | 10 | 1000 | 0.14 | | 140 | Contact Agent |
| Ortiva | Syngenta | 32 | Chlorothanil 400 g/l | 5 | 4000 | 10 | 2000 | 1 | 2 | 1000 | Contact Agent |
| | Syngenta | 21 | Azoxystrobin 80 g/l | 5 | 8000 | 10 | 2000 | 0.2 | 2 | 200 | Strobuline |

The agricultural pesticide according to the present invention may exhibit activity against any kind of agricultural pest, typically the agricultural pest is a microorganism, in particular selected from the group comprising bacteria, fungi and viruses.

More specifically the agricultural pest is selected from the group of plant pathogenic fungi, comprising Alternaria species, Aspergillus species, Blumeria species, Botrytis species, Ceratocystis species, Crinipellis species, Cephaleuros species, Colletotrichum species, Curvularia species, Erysiphaceae species, Fusaria species, Gloeosporium species, Glomerella species, Melampsora species, Myco-sphaerella species, Moniliophthora species, Magnaporthe species, Odium species, Penicillium species, Plasmopara species, Puccinia species, Phakopsora species, Podosphaera species, Pythium species, Phytophora species, Rhizopus species, Setosphaeria species, Sclerophtora species, Ustilago species, Venturia species, Verticillium species; plant pathogenic bacteria, comprising Acetobacter species, Agrobacterium species, Clavibacter species, Candidatus Liberibacter species, Curtobacterium species, Dickeya species, Erwinia species, Pantoea species, Pectobacterium species, Pseudomonas species, Ralstonia species, Xanthomonas species; plant pathogenic viruses, comprising Tobacco mosaic virus (TMV), Tomato spotted wilt virus (TSWV), Tomato yellow leaf curl virus (TYLCV), Cucumber mosaic virus (CMV), Potato virus Y (PVY), Cauliflower mosaic virus (CaMV), African cassava mosaic virus (ACMV), Plum pox virus (PPV), Brome mosaic virus (BMV), Banana bunchy top nanovirus (BBTV), Banana streak badnavirus (BSV), Barley yellow dwarf disease luteovirus complex, Maize streak mastrevirus (MSV), Maize dwarf mosaic potivirus, Rice tungro disease virus complex, Rice yellow mottle sobemovirus (RYMV), Sucarcane mosaic potivirus, Sweet potato feathery mottle potivirus (SPFMV). In still more specific embodiments, the agricultural pest is selected from the group of plant pathogenic fungi comprising Alternaria sp. (e.g. infesting fruit trees), Aspergillus flavus (e.g. infesting ananas; dry rot), Blumeria graminis (e.g. infesting crop), Botrytis cinerea (gray mold rot), Botryodiplodia theobromae (e.g. infesting lichee), Ceratocystis paradoxa (e.g. infesting ananas; soft rot), Crinipellis perniciosa (e.g. infesting cocoa; witches broom), Cephaleuros spp. (e.g. infesting mango), Colletotrichum gloeosporioides (e.g. infesting lichee), Curvularia verucculosa (e.g. infesting ananas; dry rot), Erysiphaceae sp. (powdery mildew), Fusarium oxysporum, Fusarium graminearum (crop), Fusarium oxysporum f. sp. Cubense type 1-4 (e.g. infesting bananas; fusarium wilt), Gloeosporium sp. (stored fruit; post-harvest rost), Glomerella Tucumanensis (sugar cane), Melampsora lini, Mycosphaerella graminicola, Mycosphaerella musicola (bananas; Yellow Sigatoka), Mycosphaerella fijiensis (bananas; Black Sigatoka), Moniliophthora Roreri (cocoa; frosty pdd), Magnaporthe oryzae, Odium lycopersicum (tomato; mildew), Penicillium claviforme (ananas; dry rot), Penicillium digitatum (citrus fruits; blue and green mold rot), Plasmopara viticola (grape vine; downy mildew), Pucciniomycotina (wheat; brown rust), Puccinia sorghi (corn; corn rust), Phakopsora meibomiae, Phakopsora pachyrizi (soy beans; soy bean rust), Podosphaera leucotricha (apple; apple mildew), Podosphaera aphanis (strawberry), Podosphaera pannosa (rose; powdery rose mildew, Pythium sp., Phytospora infestans (potato; late blight), Phytophtora Pod Rot (cocoa; black pod), Rhizopus stolonifer (ananas; soft rots), Rhizopus oryzae (ananas; soft rots), Setosphaeria turcica (corn; turcicum leaf spots), Ustilago maydis (corn; corn smut), Verticillium albo-atrum (mango), Venturia inaequalis (apple; apple scab), Venturia carpophila (peach; peach scab); and plant pathogenic bacteria comprising Acetobacter peroxydans (e.g. infesting ananas; marble disease), Acetobacter aceti (ananas; red rot), Agrobacterium tumefaciens, Clavibacter michiganensis, Clavibacter sepedonicus, Candidatus Liberibacter asiaticus, Curtobacterium flaccumfaciens, Dickeya dadantii, Dickeya solani, Erwinia ananas (ananas; marble disease), Erwinia amylovora (fruit trees; fire blight), Pantoea agglomerans (ananas; red rot), Pectobacterium carotovorum, Pectobacterium atrosepticum, Pseudomonas syringae pathovars, Pseudomonas savastanoi, Ralstonia solanacearum, Xanthomonas oryzae, Xanthomonas campestris pathovars, Xanthomonas axonopodis pathovars, Xanthomonas oryzae, pv. Oryzae.

A further aspect of the present invention relates to a method for protecting plants, in particular cultivated plants, against pests, comprising contacting the plants to be protected and/or the soil or nutrient medium wherein said plants are grown, with the agricultural pesticide as defined above for a predetermined time and in a sufficient amount to prevent or inhibit a harmful effect of said pests on the plants to be protected.

Typically, in this method the pesticide formulation is applied at least once in an amount of 100-5000 l, preferably 500-1500 l, per ha soil or nutrient medium.

### Example 1

### Activity Against Botrytis cinerea In Vitro

The Botrytis cinerea isolate BC 271 (which is resistent against strobilurines, anilinopyrimidines, hydrogenase inhibitors, Fenhexamide and has a reduced sensitivity against Fludioxonil) was cultivated on agar until the production of spores commenced. A spore concentration of 1×10⁵ conidiospores/ml was used for the tests.

The respective analyte (see Table 7 for a compilation of various tested analytes and standards) was added to the suspension of spores in the desired concentration and 10 μl (containing 1000 conidiospores) were placed on an agar plate (malt extract) in each repetition of the test, subsequently the plates were incubated at 20° C. Each test was repeated 4 times. The growth of fungi on the agar plates was examined after 2 days and 3 days (Table 8).

TABLE 7

| | | | Amount of | |
|---|---|---|---|---|
| | | | active | |
| | | Amount | agent | |
| | | of | applied in | |
| | | Active | vitro (mg/l | |
| | | Agent | analyt | |
| | Active | (mg/l | after 1:10 | Mixing Ratio |
| Analyt | Agent(s) | analyt) | dilution) | Analyt:Water |
| KAT | Cationic | 2500 | 250 | 1:9 |
| P2500 | Polymer | | | |
| | (PHMG) | | | |
| KAT | PHMG | 1250 | 125 | 1:9 |
| P1250 | | | | |
| KAT P625 | PHMG | 625 | 62.5 | 1:9 |
| BasD30 | Dithianon | 30 | 3 | 1:9 |
| TM PD | PHMG | 1250 | 125 | 1:9 |
| 1250 | Dithianon | 15 | 1.5 | |
| TM PD | PHMG | 625 | 62.5 | 1:9 |
| 625 | Dithianon | 15 | 1.5 | |
| ByIn312 | Propamocarb- | 312.5 | 31.25 | 1:9 |
| | hydrochloride | | | |
| | Fluopicolide | 31.25 | 3.125 | |
| TM PI | PHMG | 1250 | 125 | 1:9 |
| 1250 | Propamocarb- | 156.25 | 15.625 | |
| | hydrochloride | | | |
| | Fluopicolide | 15.625 | 1.5625 | |
| TM PI | PHMG | 625 | 62.5 | 1:9 |
| 625 | Propamocarb- | 156.25 | 15.625 | |
| | hydrochloride | | | |
| | Fluopicolide | 15.625 | 1.5625 | |
| SynAm200 | Azoxystrobin | 200 | 20 | 1:9 |
| TM PA | PHMG | 1250 | 125 | 1:9 |
| 1250 | Azoxystrobin | 100 | 10 | |
| TM PA | PHMG | 625 | 62.5 | 1:9 |
| 625 | Azoxystrobin | 100 | 10 | |
| Delan | Dithianon | 30 | 3 | 1:9 |
| | 700 g/kg | | | |
| Geoxe | Fludioxonil | 250 ppm | | |
| 0.05% | | | | |
| Switch | Fludioxonil | 250 ppm | | |
| 0.1% | Cyprodinil | 375 ppm | | |

TABLE 8

| | | Mycelium | Air | | | | |
|---|---|---|---|---|---|---|---|
| | | growth | mycelium | | | | |
| | Concen- | after 2 | after 3 | Colony diameter | | | |
| Analyt | tration | days | days | (cm) after 3 d | | | |
| Switch | 0.1% | + + + + | + + + + | 1.0 | 1.0 | 1.0 | 1.0 |
| Switch | 0.01% | + + + + | + + + + | 1.5 | 1.8 | 1.8 | 1.6 |
| Control | | + + + + | + + + + | 4.0 | 4.0 | 4.0 | 4.0 |
| (Water) | | | | | | | |
| KAT P 2500 | 10% | − − − − | − − − − | — | — | — | — |
| KAT P 1250 | 10% | − − − − | − − − − | — | — | — | — |
| KAT P 625 | 10% | − − − − | − − − − | — | — | — | — |
| BasD30 | 10% | + + + + | + + + + | 4.0 | 3.2 | 4.0 | 4.0 |
| TM PD 1250 | 10% | − − − − | − − − − | — | — | — | — |
| TM PD 625 | 10% | − − − − | − − − − | — | — | — | — |
| Byln312 | 10% | + + + + | + + + + | 4.5 | 4.0 | 4.0 | 4.0 |
| TM P1 1250 | 10% | − − − − | − − − − | — | — | — | — |
| TM PI 625 | 10% | − − − − | − − − − | — | — | — | — |
| SynAm200 | 10% | + + + + | + + + + | 4.5 | 4.5 | 4.0 | 4.0 |
| TM PA 1250 | 10% | − − − − | − − − − | — | — | — | — |
| TM Pa 625 | 10% | − − − − | − − − − | — | — | — | — |

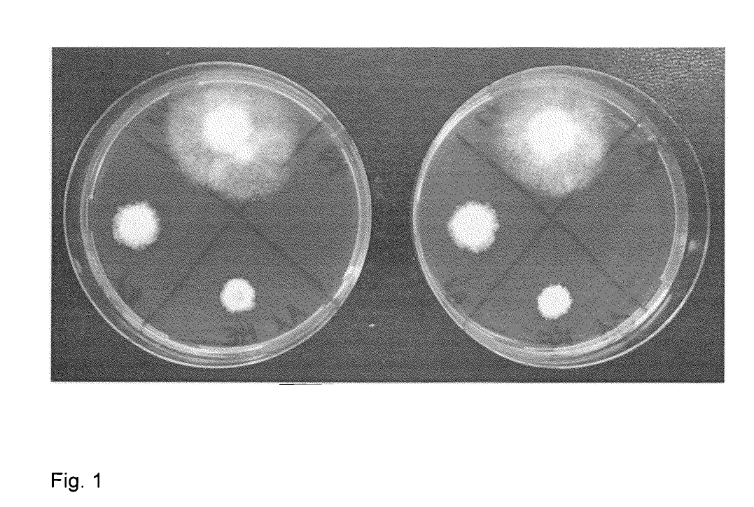

FIG. 1 demonstrates the results for untreated control (top quarter), 10% Kat P 2500 (right), 0.1% Switch (bottom) and 0.01% Switch (left) after 3 days incubation at 20° C. (2 of 4 repeats).

### SUMMARY

After application of the Botrytis conidiospores onto agar plates, the spores germinated in the control as well as in the mixtures with Switch (0.1% and 0.01%), BasD30 (10%), ByIn312 (10%) and SynAm200 (10%), resulting in visible mycelium after 2 days and air mycelium after 3 days. After 3 days the colonies of the untreated control had grown to a size of ca. 4 cm diameter. 0.1% Switch decreased the growth of the partially resistent Botrytis strain to ca. 1 cm and 0.01% Switch to 1.5-1.8 cm. (The growth of sensitive Botrytis strains on agar is completely inhibited by 0.1% Switch).

The analytes KAT P 2500, KAT P 1250, KAT P 625, TM PD 1250, TM PD 625, TM PI 1250, TM PI 625, TM PA 1250 and TM PA 625 (10% dilution each) completely inhibited the development of the Botrytis isolate Bc 271.

### Example 2

### Activity Against Venturia inaequalis In Vitro

Infested leaves of an apple tree (Jonagold; originally harvested in the botanical garden of the University of Konstanz and further propagated in the greenhouse) which had been stored frozen were thawed and rinsed with water. The resulting suspension of conididospores was mixed with the various analytes (see Table 7 for a compilation of various tested analytes), so that the analytes were diluted 1:10, i.e. used in a concentration of 10%. 40 μl of each mixture were applied to aqueous agar and these plates were incubated at 20° C. for 24 h. Subsequently, for each test batch at least 200 conidiospores were assessed for germination using a microscope and the proportion of germinated conidiospores (percent) was calculated (Table 9). The tests were done as a double determination and were repeated once.

TABLE 9

| | | | Degree of | |
|---|---|---|---|---|
| | Conc. | Conc. | efficacy | Standard |
| Treatment | (%) | (ml/l) | (%) | deviation |
| Delan WG | 0.05 | 0.5 | 99.7 | 0.6 |
| (315 ppm | | | | |
| dithianon) | | | | |
| Delan WG | 0.0005 | 0.005 | 98.7 | 1.6 |
| (3.15 ppm | | | | |
| dithianon) | | | | |
| KAT P 2500 | 10 | 100 | 99.7 | 0.6 |
| KAT P 1250 | 10 | 100 | 99.2 | 0.9 |
| KAT P 625 | 10 | 100 | 99.5 | 0.9 |
| BasD30 | 10 | 100 | 99.0 | 1.2 |
| TM PD 1250 | 10 | 100 | 99.8 | 0.4 |
| TM PD 625 | 10 | 100 | 99.7 | 0.6 |
| ByIn312 | 10 | 100 | 4.9 | 20.6 |
| TM PI 1250 | 10 | 100 | 99.8 | 0.5 |
| TM PI 625 | 10 | 100 | 99.2 | 0.9 |
| SynAm200 | 10 | 100 | 98.8 | 1.4 |
| TM PA 1250 | 10 | 100 | 98.9 | 1.7 |
| TM PA 626 | 10 | 100 | 99.0 | 0.2 |

### SUMMARY

The average germination rate of the conidiospores in the untreated control was 36.3%. ByIn312 was not able to inhibit germination of the spores. Each of the other analytes demonstrated a degree of efficacy against this pathogen above 98.5%. The reference standard Delan WG (dithianon) reduced the germination by 99.7% if applied in the recommended concentration of 0.05% and by 98.7% if applied in a concentration of 0.0005%.

1. An agricultural pesticide, comprising a substance selected from the group consisting of poly(alkyl)-guanidines, poly(alkyl)biguanidines, polyguanines, octenidin, and blends thereof.

2. The agricultural pesticide according to claim 1, wherein an alkyl chain length of a monomer of the poly(alkyl)guanidines or poly(alkyl)biguanidines is in a range from C₂-C₁₄.

3. The agricultural pesticide according to claim 1, wherein the poly(alkyl)guanidine is selected from the group consisting of a poly(tetramethylen)guanidine, poly(hexamethylen)guanidine (PHMG), a poly(octa-methylen)guanidine, poly(decamethylen)guanidine, and poly(dodecamethylen)guanidine.

4. The agricultural pesticide according to claim 1, wherein the substance is present in combination with at least one other component exhibiting activity against agricultural pests.

5. The agricultural pesticide according to claim 4, wherein said least one other component exhibiting activity against agricultural pests represents at least one active agent of a commercially known pesticide.

6. The agricultural pesticide according to claim 4, wherein said least one other component exhibiting activity against agricultural pests is a pesticide acting upon contacting plants.

7. The agricultural pesticide according to claim 4, wherein said least one other component exhibiting activity against agricultural pests is selected from the group of compounds consisting of diazoles, triazoles, benzimidazoles, pyrazoles, benzimidazole carbamates, dithiocarbamates, carboxamides, dicarboximides, anilides, nicotinamides, amines, ammonium compounds, pyrimidines, pyridines, piperidines, morpholines, pyrroles, diazines, strobulines, nitriles, and cinnamic acids.

8. The agricultural pesticide according to claim 7, wherein said least one other component exhibiting activity against agricultural pests is selected from the group consisting of propyl-3-(dimethyl amino)propylcarbamate hydrochloride, 8-tert-butyl-1,4-dioxaspiro[4.5]decan-2-ylmethyl-(ethyl)(propyl)amine, (RS)-2-4-chlorophenyl)-N-[3-methoxy-4-(prop-2-ynyloxy)phenethyl]-2-(prop-2-ynyloxy)acetamide, methyl N-methoxyacetyl)-N-2,6-xylyl-D-alaninate, N-propyl-N-[2-2,4,6-trichlorophenoxy)-ethyl]imidazole-1-carboxamide, N-4,6-dimethylpyrimidin-2-yl)aniline, methyl (E)-3-methoxy-2-{2-6-(trifluoro-methyl)pyridin-2-yloxymethyl]-phenyl}acrylate, (E,E)-methoxyimino-{2-[1-(3-trifluoromethyl-phenyl)-ethylideneaminooxymethyl]-phenyl}-acetic acid methyl ester, (E)-{2-[6-(2-chlorophenoxy)-5-fluoropyrimidin-4-yloxy]phenyl}(5,6-dihydro-1,4,2-dioxazin-3-yl)methanone, 3-(difluoromethyl)-1-methyl-N-(3′,4′,5′-trifluoro-biphenyl-2-yl)pyrazole-4-carboxamide, S-allyl 5-amino-2,3-dihydro-2-isopropyl-3-oxo-4-(o-tolyl)pyrazole-1-carbothioate, (E,Z 4-[3-(4-chlorophenyl)-3-(3,4-dimethoxyphenyl)acryloyl]morpholine, Tetrachloroisophthalonitrile, 3-(3,5-di chlorophenyl)-N-isopropyl-2,4-dioxo-imidazolidine-1-carboxamide, N-(3′,4′-dichloro-5-fluorobiphenyl-2-yl)-3-(difluoromethyl)-1-methylpyrazole-4-carboxamide, dimethyl 4,4′-(o-phenylene)bis(3-thioallophanate), 2-chloro-N-(4′-chlorobiphenyl-2-yl)nicotinamide, 5,10-dihydro-5,10-dioxonaphtho[2,3-b]-1,4-dithi-in-2,3-dicarbonitrile, (E,Z 4-[3-(4-chlorophenyl)-3-(3,4-dimethoxyphenyl)-acryloyl]morpholine, methyl (E)-2-{2[6-(2-cyanophenoxy)pyrimidin-4-yloxy)phenyl}3-methoxyacrylate, 2,6-dichloro-N-[3-chloro-5-(trifluoromethyl)-2-pyridylmethyl)benzamide, (+/−)-cis-4-[3-(4-tert-butylphenyl)-2-methylpropyl]-2,6-dimethylmorpholine, (RS)-1-[3-(4-tert-butylphenyl)-2-methylpropyl)-piperidine, (RS)-1-p-chlorophenyl-4,4-dimethyl-3-(1H-1,2,4-triazol-1-ylmethyl)pentan-3-ol, (1RS,2RS,1RS,2SR)-1-(4-chlorophenoxy)-3,3-dimethyl-1-(1h-1,2,4-triazole-1-yl)butan-2-ol, 1-(2,4-dichloro-beta-propylphenethyl)-1H-1,2,4-triazole, (1RS,5RS,1RS,5SR)-5-(4-chlorobenzyl)-2,2-dimethyl-1-(1H-1,2,4-triazol-ylmethyl)cyclopentanol, (RS)-2-[2-(1-chlorocyclopropyl)-3-[2-chlorophenyl)-2-hydroxypropyl]-2,4-dihydro-1,2,4-triazole-3-thione, (2RS,3RS)-1-[3-(2-chlorophenyl)-2-(4-fluorophenyl)-oxiran-2-ylmethyl]-1H-1,2,4-triazole, (+/−)-(E)-5+(4-chlorobenzylidene)-2-2-dimethyl-1-(1H-1,2,4-triazol-1-methyl)cyclopentanol, (+/−)-1-[2-(2,4-di chlorophenyl)-4-propyl-1,3-dioxolan-2-ylmethyl]-1H-1,2,4-triazole, manganese ethylenebis-(dithiocarbamate) polymeric complex with zinc salt, and methyl-(E)-2-methoxyimino-(2)-o-tolyl-oxymethyl-(phenyl)acetate.

9. The agricultural pesticide according to claim 1, wherein the substance is present in an aqueous formulation in a proportion between 10 ppm and 200,000 ppm of a total composition.

10. The agricultural pesticide according to claim 4, wherein the substance is present in a proportion between 10 ppm and 200,000 ppm of a total composition.

11. The agricultural pesticide according to claim 4, wherein said at least one other component exhibiting activity against agricultural pests is present in a proportion between 5 ppm and 20,000 ppm of a total composition.

12. The agricultural pesticide according to claim 1, wherein the poly(alkyl)guanidines, poly(alkyl)biguanidines or polyguanines have a molecular weight in a range from 500 to 100,000 Dalton.

13. The agricultural pesticide according to claim 1, which is an aqueous composition comprising poly(hexamethylen)guanidine in an amount of 20-8000 ppm, and one or more of compounds selected from the group consisting of 2,6-dichloro-N-[3-chloro-5-(trifluoromethyl)-2-pyridylmethyl)benzamide, 5,10-dihydro-5,10-dioxonaphtho[2,3-b]-1,4-dithi-in-2,3-dicarbonitrile, methyl (E)-2-{2[6-(2-cyanophenoxy)-pyrimidin-4-yloxy)-phenyl}3-methoxyacrylate, and propyl-3-(dimethylamino)propylcarbamate hydrochloride in an amount of 10-1000 ppm each and a balance of water.

14. The agricultural pesticide according to claim 1, wherein the agricultural pest is a microorganism selected from the group consisting of bacteria, fungi and viruses.

15. The agricultural pesticide according to claim 14, wherein the agricultural pest is selected from the group consisting of Alternaria species, Aspergillus species, Blumeria species, Botrytis species, Ceratocystis species, Crinipellis species, Cephaleuros species, Colletotrichum species, Curvularia species, Erysiphaceae species, Fusaria species, Gloeosporium species, Glomerella species, Melampsora species, Mycosphaerella species, Moniliophthora species, Magnaporthe species, Odium species, Penicillium species, Plasmopara species, Puccinia species, Phakopsora species, Podosphaera species, Pythium species, Phytophora species, Rhizopus species, Setosphaeria species, Sclerophtora species, Ustilago species, Venturia species, Verticillium species, Acetobacter species, Agrobacterium species, Clavibacter species, Candidatus Liberibacter species, Curtobacterium species, Dickeya species, Erwinia species, Pantoea species, Pectobacterium species, Pseudomonas species, Ralstonia species, Xanthomonas species, Tobacco mosaic virus (TMV), Tomato spotted wilt virus (TSWV), Tomato yellow leaf curl virus (TYLCV), Cucumber mosaic virus (CMV), Potato virus Y (PVY), Cauliflower mosaic virus (CaMV), African cassava mosaic virus (ACMV), Plum pox virus (PPV), Brome mosaic virus (BMV), Banana bunchy top nanovirus (BBTV), Banana streak badnavirus (BSV), Barley yellow dwarf disease luteovirus complex, Maize streak mastrevirus (MSV), Maize dwarf mosaic potivirus, Rice tungro disease virus complex, Rice yellow mottle sobemovirus (RYMV), Sucarcane mosaic potivirus, and Sweet potato feathery mottle potivirus (SPFMV).

16. The agricultural pesticide according to claim 15, wherein the agricultural pest is selected from the group consisting of Alternaria sp., Aspergillus flavus, Blumeria graminis, Botrytis cinerea, Botryodiplodia theobromae, Ceratocystis paradoxa, crinipellis, perniciosa, Cephaleuros spp., Colleto-trichum gloeosporioides, Curvularia verucculosa, Erysiphaceae sp., Fusarium oxysporum, Fusarium graminearum, Fusarium oxysporum f sp. Cubense type 1-4, Gloeosporium sp., Glomerella Tucumanensis, Melampsora lini, Mycosphaerella graminicola, Mycosphaerella musicola, Mycosphaerella fijiensis, Moniliophthora Roreri, Magnaporthe oryzae, Odium lycopersicum, Penicillium claviforme, Penicillium digitatum, Plasmopara viticola, Pucciniomycotina, Puccinia sorghi, Phakopsora meibomiae, Phakopsora pachyrizi, Podosphaera leucotricha, Podosphaera aphanis, Podosphaera pannosa, Pythium sp., Phytospora infestans, Phytophtora Pod Rot, Rhizopus stolonifer, Rhizopus oryzae, Setosphaeria turcica, Ustilago maydis, Verticillium albo-atrum, Venturia inaequalis, Venturia carpophilia, Acetobacter peroxydans, Acetobacter aceti, Agrobacterium tumefaciens, Clavibacter michiganensis, Clavibacter sepedonicus, Candidatus Liberibacter asiaticus, Curtobacterium flaccumfaciens, Dickeya dadantii, Dickeya solani, Erwinia ananas, Erwinia Amylovora, Pantoea agglomerans, Pectobacterium carotovorum, Pectobacterium atrosepticum, Pseudomonas syringae pathovars, Pseudomonas savastanoi, Ralstonia solanacearum, Xanthomonas oryzae, Xanthomonas campestris pathovars, Xanthomonas axonopodis pathovars, Xanthomonas oryzae, and pv. Oryzae.

17. A method for protecting plants against pests, comprising contacting the plants to be protected and/or soil or a nutrient medium wherein said plants are grown, with the agricultural pesticide according to claim 1 for a predetermined time and in a sufficient amount to prevent or inhibit a harmful effect of said pests on the plants to be protected.

18. The method according to claim 17, wherein the pesticide formulation is applied at least once in an amount of 100-5000 l, per ha soil or nutrient medium.
